(19) United States
(12) Patent Application Publication
(10) Pub. No.: US 2025/0345859 A1
(43) Pub. Date: Nov. 13, 2025

(54) Thixotropic 3D Metal Printing System

(71) Applicant: Drexel University, Philadelphia, PA (US)

(72) Inventors: Gongyao Zhou, Wilmington, DE (US); Jie Xu, Philadelphia, PA (US)

(21) Appl. No.: 19/205,350

(22) Filed: May 12, 2025

Related U.S. Application Data
(60) Provisional application No. 63/645,922, filed on May 12, 2024.

(51) Int. Cl. B22F 12/53; B22F 10/20; B22F 12/13; B22F 12/20; B22F 12/70; B33Y 30/00

(52) U.S. Cl. CPC B22F 12/53; B22F 10/20; B22F 12/13; B22F 12/20; B22F 12/70; B33Y 30/00; B22F 2201/10; B22F 2202/01; B22F 2301/30; B22F 2998/10

(57) ABSTRACT

A thixotropic mixing device is provided. The device includes a mixer base, a stationary mixing disk attached to the mixer base, a rotating disk located above the stationary mixing disk, and a transmission device configured to rotate the rotating disk. A shaft extends through the transmission device and the rotating disk. A thixotropic printing device is also provided and includes a heating chamber configured to accept a filament. The filament contains grains having a refined micro grain size. An extrusion system is located downstream of the heating chamber. The extrusion system is configured to convert the filament into a semi-solid slurry. The extrusion system has a cooler configured to cool the filament and a nozzle downstream of the cooler. The nozzle has a nozzle diameter at least ten times greater than the grains size. A substrate is configured to receive a discharge from the nozzle.

### BACKGROUND OF THE INVENTION

### Field of the Invention

The invention relates to a system for printing three-dimensional (3D) articles using a thixotropic material.

### Description of the Related Art

Biodegradable metals, especially zinc (Zn) and magnesium (Mg) based alloys, have gained significant attention in recent years due to their degradation characteristics and higher mechanical strength compared to biodegradable polymers. They are excellent materials for numerous biomedical and implanted devices such as plates, screws, pins, stents, rods, anchors, and staples used in orthopedic, spinal, and vascular surgery. Through alloying design, desired in vivo degradation kinetics and suitable mechanical properties can both be obtained. However, broad use of such bio-metals is greatly affected by the lack of a rapid and economical process for manufacturing into patient-oriented, customizable devices. Currently, the only industry-proven manufacturing process for making Zn—Mg based medical devices such as stents is cutting (e.g. by laser) which is expensive and has limited capability in creating complex 3D geometry.

Initial analysis of the markets indicates that laser melting/sintering of powders is not suitable for chemically reactive metals like Mg, Zn and AI. The high laser energy needed to break the passivated oxidation layer covering these metals leads to poor fusion quality due to undesired metallurgical defects such as porosity, cracking, and evaporation of alloying elements. Also, the powder-based 3D printing process has complex subprocesses of expensive fine metal powder making (20-40 microns), post processing in powder shaking/clearing, de-binding, sintering/infiltration, and heat treatment; in further, the fine powder environment is not healthy and unsafe. On other side, for metallic materials, all commercially available jetting/extrusion machines rely on a binder material (mostly organic materials) to form a printable compound. Direct printing of molten metal for controllable freeform 3D fabrication has not been achieved.

It would be beneficial to provide a process for 3D printing of Zn—Mg based medical devices.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a thixotropic printing device. The device includes a mixer base, a stationary mixing disk attached to the mixer base, a rotating disk located above the stationary mixing disk, and a transmission device configured to rotate the rotating disk. A shaft extends through the transmission device and the rotating disk and an inlet port extends through the shaft. An outlet port is in communication with the inlet port.

A method of mixing metals and 3D printing the metals is also provided.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic drawing showing an exemplary process of thixotropic shearing-mixing and printing of a Mg—Zn alloy according to the present invention;

FIG. 2 is a perspective view of a mixing and extruding device used with the presenting.

FIG. 3A is a blend domain diagram showing a globular slurry with grains uniformly dispersed in a liquid;

FIG. 3B is a blend domain diagram showing a dendritic slurry;

FIG. 3C is a blend domain diagram showing grains of different sizes dispersed in a liquid;

FIG. 3D is a blend domain diagram showing grains at the surface of a liquid balancing surface tension effect;

FIG. 4 is a perspective view of an exemplary thixotropic mixer according to the present invention;

FIG. 5 is an exploded perspective view of the mixer of FIG. 4;

FIG. 6 is a perspective view of an exemplary mixing disc with a spiral groove;

FIG. 7 is a perspective view of an alternative exemplary mixing disc with milling grooves;

FIG. 8 is a perspective view of a medical interference screw manufactured according to the present invention;

FIG. 9 is a schematic view of a rapid heat treatment system according to an exemplary embodiment of the present invention;

FIG. 10A is a graph showing a relationship between time for globular grain development, average grain area, and average grain diameter in relation to temperature;

FIG. 10B is a photo showing grain structure formed using the process of the present invention;

FIG. 11A is a schematic view of an extrusion system for thixotropic metal additive manufacturing;

FIG. 11B is a photo showing major components of the extrusion system of FIG. 11A;

FIG. 12A is a schematic view of the extrusion system of FIG. 11A with an inert gas protection mechanism;

FIG. 12B is a photo of the gas protection system of FIG. 12A;

FIG. 13 is a schematic view of a first layer and substrate adhesion mechanism;

FIG. 14 is a heat transfer model between a stainless steel substrate and a printed filament;

FIG. 15 is a schematic view of a complete thixotropic 3D metal printing according to an exemplary embodiment of the present invention;

FIG. 16 is a photo of a metal printer according to an exemplary embodiment of the present invention;

FIG. 17A is a top plan view of a planar spiral metal printed according to the present invention;

FIG. 17B is a perspective view of a stacked spiral metal printed according to the present invention;

FIG. 17C is a perspective view of a stacked metal basket printed according to the present invention;

FIG. 17D is a perspective view of a 2-layer grid structure metal printed according to the present invention; and

FIG. 17E is a top plan view of a plate metal printed according to the present invention.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

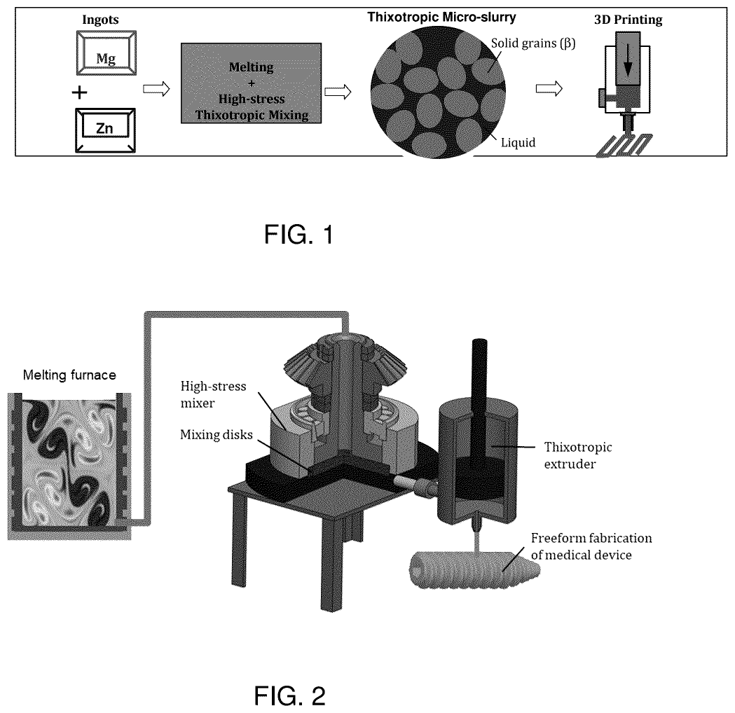

The present invention provides a process for thixotropic mixing of Zn—Mg based alloys and 3D printing for the fabrication of customizable medical devices made of Zn—Mg based bio-alloys, as shown in the schematic of FIG. 1.

A two-phase fluid-solid structure with a finely dispersed morphology at a high solid-to-liquid ratio can be created for Zn—Mg alloys by novel thixotropic mixing, which can effectively increase the thixotropy for 3D printing by extrusion and jetting. The process and equipment design allow this unique phase structure materials produced by shear-mixing to be retained in the printing stage, as shown in FIG. 2.

The inventive process can also be adapted to fabrication of light metals, such as Mg, Al, and Zn based alloys in direct 3D printing for broad industrial applications in automotive, aerospace, and infrastructure industry. Extrusion-based freeform fabrication of bio-metallic devices combining strength, biocompatibility, and suitable biodegradability is highly desirable for medical and surgical applications. Animal and human studies have shown that Zn—Mg alloys can be safely used as bioabsorbable scaffolds. Several cardiovascular and orthopedic biodegradable metallic devices have recently been approved for use in humans. For metallic materials, all commercially available jetting/extrusion machines rely on a binder material (mostly organic materials) for formulating a printable compound; direct printing of molten metal for controllable freeform 3D fabrication has not been achieved prior to this invention. The thixotropic mixing and 3D printing technology resulting from this project dramatically impacts skeletal and soft tissue fixation tools, vascular inflation stents, and bone tissue scaffolds.

The present invention is broken into four parts, namely: 1: Design and develop a unique thixotropic fine-grain filament apparatus for direct metal printing to solve the dimensional accuracy and clogging problems, by rapidly heating a raw metal wire and then immediately quenching the wire to receive a fine globular grain-structure filament; 2: Determine three (low, middle, and high) temperature zones to accurately control the metal filament feeding through solid, semi-solid, and thixotropic three status with proper cooling; 3: Design and construct an innovative inert gas protection system, which is a compact, flexible (multi-degree movement), heat resistant fiber fabric tent using an argon gas protection system with gas flow control and oxygen concentration detector; and 4: Develop a hot coating theory and thermal transfer model for metal-substrate adhesion (weak bonding) and layer to layer fusing (strong bonding) by using PID control of a substrate heating system, and achieve accurate control of printing front-slurry's solid/liquid fraction rate based on semisolid phase-diagram temperature window.

### Technical Discussion

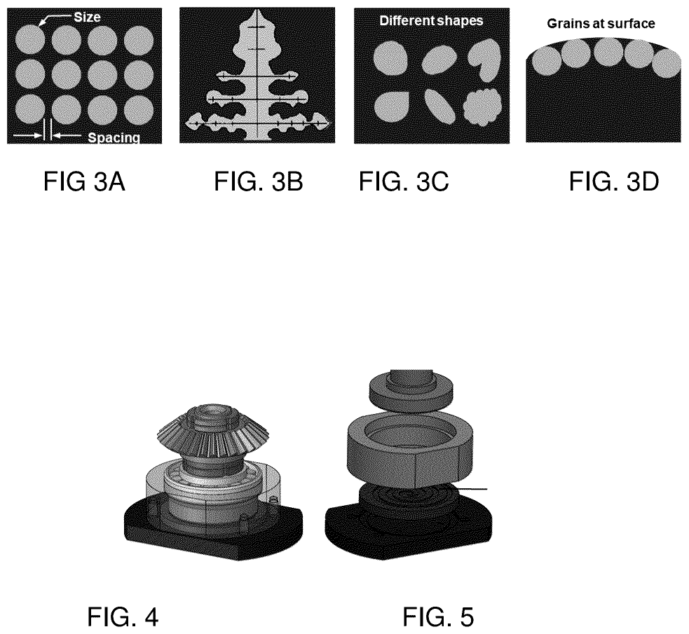

A liquid-like slurry (or semi-solid paste) that is highly thixotropic, containing uniformly dispersed fine grains in a continuous liquid matrix, is highly demanded in 3D printing of metal alloys using cost-effective extrusion-based processes. The desired fluidic morphology is shown in FIG. 3A. The spacing and size of the grains play an important role in affecting the flow behavior, and therefore the printability. For 3D printing, fine particles of micrometer size or even smaller are needed, so a smooth printing process is enabled. Especially, a dendritic slurry, shown in FIG. 3B is more solid-like, but is difficult to be uniformly extruded, so it should be avoided in 3D printing. Furthermore, printability is affected by grain sizes, shapes (FIGS. 3A and 3C), and position (FIG. 3D). A better processing/mixing method for preparing the desired liquid-like alloy paste has been developed.

The present invention addresses innovations to overcome this technical bottleneck and obtain understanding of basic physics and materials science so that design principles for process scale-up can be devised. The inventive manufacturing process is especially useful for freeform fabrication of Zn—Mg based bio-alloys that have a low melting temperature and cannot be easily processed using existing powder-based additive manufacturing processes.

It is well known that both Mg and Zn are essential elements in the human body both for repair and regeneration of soft and hard tissues. Magnesium is also essential in calcium absorption, while zinc plays a critical role in regulation of phosphate and other inorganic minerals. In addition, research has been conducted recently on processing of Mg—Zn alloys, and the results demonstrated that incorporation of Mg into bulk Zn or Zn into bulk Mg both can significantly enhance biodegradable characteristics and mechanical properties owing to development of refined grain structures. Mg—Zn alloys are also compatible with several other essential elements such as Ca.

For example, a ternary alloy containing Mg, Zn and Ca has attracted special interest in bone tissue engineering. Therefore, the present invention focuses on Mg and Zn as the base elements for developing the necessary alloy for the inventive process. This alloy system is also considered advantageous in thixotropic processing because both metals are low in melting temperature, and yet the difference in melting temperature between Mg and Zn is large (˜130° C.). Therefore, a large processing temperature window can be created for development of thixotropic slurries. Zn can be dissolved into Mg to a relatively high concentration of about 6.2 wt %. This Mg-rich phase has a higher melting temperature than a Zn-rich phase, so the Mg-rich phase can serve as a solid β-phase in the slurry. From the published phase diagram of Mg—Zn alloys, a large range of Zn molar percentage up to about 28% can be explored for formation of a two-phase system (liquid+solid β-phase). To further increase the process window, we tested the effect of addition of Ca, of which Mg—Ca alloys of a large range of mixing composition have already been demonstrated. It is known that that some rare-earth elements like WE43, even at a negligibly small amount (so not to affect biocompatibility), can significantly enhance grain structures of zinc-rich Zn—Mg alloys.

Alloy preparation

Both Zn-rich (labeled as Zn—Mg) and Mg-rich (labeled as Mg—Zn) alloys are prepared by melting under inner gas protection. Commercial pure Zn (99.9%) and Mg (99.9%) metal blocks are melted and mixed in a ceramic crucible under SF₆ and CO₂ protection. The crucible with Zn and Mg ingots is placed in the furnace chamber, followed by air evacuation and SF₆ and CO₂ filling. After Zn and Mg are both melted, vigorous stirring are applied to form a uniform solution, which is subsequently cooled with the furnace. Hot extrusion is also conducted using an inner environment.

### Mechanical and Physical Tests

The mechanical properties of Zn—Mg and Mg—Zn alloys can be regulated in a relatively large range by adjusting the alloy composition and heat treatment conditions. Therefore, the mixing composition is varied in a large range, and its effect on mechanical properties is studied to produce a material with optimized mechanical properties for implanted devices. Different cooling rates in heat treatment are studied in terms of their effects on morphological changes (phase structure and phase size) and consequently mechanical property changes. Corrosion tests are conducted using simulated body fluids.

### Biocompatibility Test

Cytotoxicity evaluations are conducted using in vitro (with an L-929 cell line) tests, with additional in vivo tests outsourced. The effect of the Mg—Zn or Zn—Mg implanting materials on the activity of osteoblasts and osteocytes are evaluated using standard staining methods. Radiographic examinations are performed to track the degradation of these materials. The protocols for these biocompatibility tests have been established and have been used in previous work of biomaterials for fixation applications.

### Structure/Morphology Characterizations

In the conceptual process design (FIG. 1), simple α and β phases have been used for illustration purpose. In the actual alloy, the phase morphology can be much more complex. Therefore, the solids included in the thixotropic slurry could be of different types. An in-depth morphological study supported by advanced characterization techniques including optical microscopy, scanning electron microscopy (SEM), x-ray diffraction, energy-dispersive spectroscopy (EDS), among others, is performed. The phase diagram is important for designing the process window for the needed a and B phases. Thermal analyses including differential scanning calorimetry (DSC) and differential thermal analysis (DTA) is used for constructing the solidus and liquidus of Mg and Zn alloys.

Rheological Study

A desired morphology of the micro-slurry for 3D printing has been exemplified in FIG. 3. In addition to achieving a large degree of thixotropy, it is also found that finely dispersed grains presented at the surface stabilize the surface and reduce the effective surface tension, as illustrated in FIG. 3D. For a surface with large amount of solid inclusion, surface shrinkage becomes more difficult (due to solid-solid interaction), thus effectively reducing surface tension. This effect has been used extensively for interfacial compatibilization in materials processing. The reduction of surface tension not only stabilizes the surface, but it also allows the printed material to attach to a surface (easy for wetting). Moreover, for the solidified alloy, improved mechanical properties and corrosion characteristics with a refined grain structure are also anticipated.

### Relation Between Thixotropy and Printability

The thixotropy of the alloy micro-slurry generated from high-stress mixing highly correlates with the phase morphology, including size, shape, and distribution, as well as grain-to-grain interactions. For a thixotropic fluid, an initially high stress for flow to start and then reduction of viscosity due to pseudo-plasticity is seen. Upon cessation of flow, the viscosity of fluid rapidly increases. These characteristics are considered essential for extrusion and deposition of the micro-slurry in 3D printing. Particularly, the yield stress in the thixotropy is crucial in the proposed 3D printing process. First, the yield stress during extrusion neutralizes the negative effects from the high surface tension and allows a liquid filament to be generated. Second, the yield stress regenerated after cessation of flow (end of extrusion) enables quick attachment and stabilization of the liquid thread onto the substrate. This latter property is critical for controllable deposition of the liquid filament with a high geometrical control capability, yet thixotropic occurs at a faster time scale so that better accuracy of printing is achieved. This is understandable by considering a counterexample where a molten material without a yield stress tends to spread or sag on the substrate. Besides the yield stress, the pseudo-plastic properties, i.e., the shear thinning characteristic, is also considered advantageous in achieving better printability of the micro-slurry. With shear thinning, the micro-slurry can flow more easily in the capillary orifice at a higher shear rate, thus enabling high-speed extrusion.

From the above discussion, it becomes clear that desired thixotropy for enhanced printability contains three features: (1) a shear-thinning characteristic to enable easy flow inside the capillary orifice, (2) an initial yield stress (or fluid stress) during extrusion to counterbalance the negative effects of high surface tension, and (3) a yield stress regenerated after cessation of flow to stabilize the geometry. A more quantitative relation between thixotropy and printability in 3D printing is established. Basic unit geometries such as dots, lines, circles, and areas with variable thickness and depth are printed at varied speeds to evaluate the printing accuracy and throughput. It is also worth emphasizing that the flow resistance (yield stress or equivalent viscosity) is not a static property. In fact, one can define three types of yield stresses: static (achieved after long resting time), dynamic (that holds for the period where the yield stress increases with time when the material is in rest after being sheared), and isostructural (corresponding to the value which would be measured immediately after shearing the material). The isostructural yield stress is especially important to 3D printing because this property is directly related to printing accuracy. Therefore, the relation between the isostructural yield stress and printability has been carefully studied.

### Processing-Structure-Property Relation

First, the thixotropic property is largely dependent on the morphology of the micro-slurry, including solid-to-liquid fraction and the size and shape of solid grains. Second, the morphology developed during printing greatly influences the properties of the printed parts. At the same time, the structural and morphological development during mixing and extrusion is largely contingent on the processing recipe and conditions. High-stress mixing can lead to a refined grain structure of the micro-slurry. In fact, previous studies in alloy preparation with agitation have already shown such a dependency.

What solid fraction in the micro-slurry is suitable for desired thixotropy is an important question to answer. It is known that a solid-like material would result if the percolation threshold (around a volume fraction of 0.65) should be reached. We focused on attaining a micro-slurry with solid faction below-0.6 (but not limited).

### Thixotropic Shearing-Mixing and 3D Printing Process

An integrated process combining thixotropic shearing-mixing and thixotropic extrusion is provided for freeform fabrication of Zn and Mg based alloys. This process integration is considered advantageous for preserving the mixing morphology and using the micro-slurry directly in 3D printing. If the liquid-like micro-slurry obtained from thixotropic shearing-mixing is cooled first and then re-melted for 3D printing, a change of phase morphology occurs due to recrystallization and re-melting. This is understandable from thermodynamics point of view since the structure from mixing is not an equivalent structure. During heating and cooling, thermal interdiffusion can alter the composition of phases as well as phase sizes. In the inventive design, the overall process setup is modulated, containing two units: thixotropic mixing and 3D printing, as shown in FIG. 2, then the system is used to print a biodegradable interference screw.

### Thixotropic Mixer Design

By thixotropic molding, aluminum alloys and magnesium alloys are quickly processed into thin-wall products with improved mechanical performance. However, the standard equipment for thixotropic casting/molding produces relatively large-sized grain structures, usually on the order of 100 microns or larger, and containing dendritic inclusions. These semisolid materials, therefore, are not suitable for freeform fabrication. In fact, a more liquid-like micro-slurry is needed for 3D printing. For this purpose, large mixing stress is needed to break dendritic inclusions and refine the grain structure. Standard batch mixers and screw-based continuous mixers are laminar flow mixers with a relatively low mixing stress scarcely exceeding 0.1 MPa, which is orders of magnitude lower than that needed to break up dendrites (or suppress formation of dendrites). Instead, devices with direct solid-to-solid interactions such as particle mills can develop very high stresses; however, particle mills such as ball mills are not suitable for processing liquid-like slurries either. Therefore, a new mixer design is provided where fluidic transport and high stress can both be achieved in a single device.

The overall design of the mixer is shown in FIG. 4, with an exploded view to show the engaging pair of disks shown in FIG. 5. This disk is retrofitted onto an existing torque generator through a bevel gear for engagement. The mixer includes a mixing disk (1), a mixer base (2), a support sleeve (3), a rotating disk with a shaft (4), a roller bearing (5), lock nuts (6), a transmission device in the form of a bevel gear (7), and lock nuts (8). The mixer mimics the function of a classic stone mill for making bean curds but is now installed with features for fluidic transport. Materials are fed into the mixer through the hole in the rotating disk. With the rotating disk, a drag flow is developed in the gap between the engaging disks.

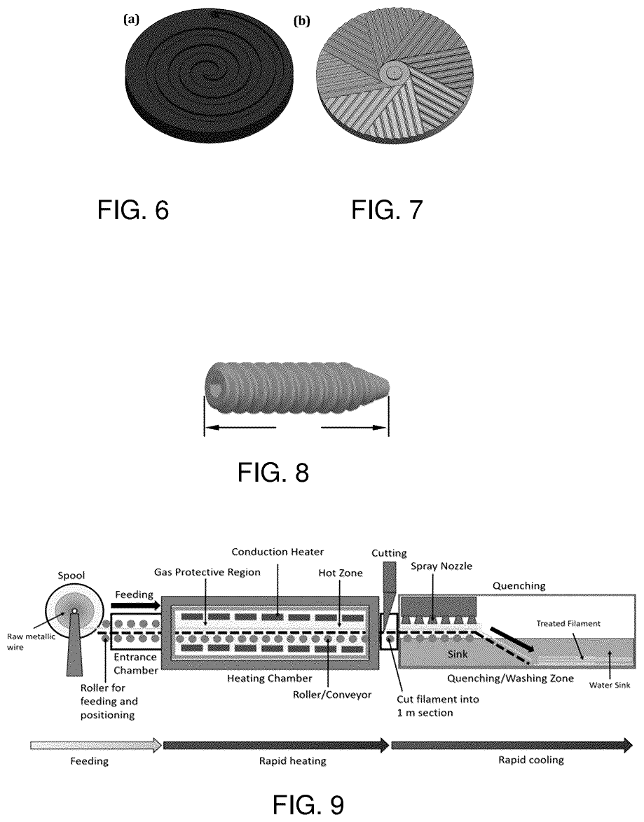

Thus, the material flows through the channel on the surface of the mixing disk (see FIG. 6). The material is dragged by the rotating disk (4) from the center of the mixing disk (1) to the outer edge along the channel. An exit hole is drilled at the end of the helical channel and connected to the discharging port of the mixer. The mixing disk (1) and the mixer base (2) are bolted together and can be disassembled to accommodate a mixing disk of a different design. The support sleeve (3) is also bolted to the mixer base (2) to create necessary guidance for the rotating disk (4). The support sleeve (3) is further used as the bearing housing. On the shaft of the rotating disk (4), a tapered roller bearing (5) is installed, which is used to carry both axial and radial loads. Two lock nuts (6) are used to fix the axial position of the bearing (5) on the shaft (4). A bevel gear (7) is also mounted on the shaft of the rotating disk (4). Thus, the torque from the motor can be transferred to the rotating disk (4). Similarly, two lock nuts (8) are used to lock the axial position of the bevel gear (7). To accommodate the high temperature exceeding 550° C. during thixotropic processing, the critical elements of the mixer including the two disks and the housing will be made of high-temperature alloys, not reactive to molten Mg and Zn.

FIGS. 6 and 7 show two examples of mixing disks to be considered. The spiral groove design (FIG. 6) can facilitate effective fluidic transport by drag flow between two engaging disks. To produce high mixing stress, interacting features are included. FIG. 7 shows a design with protruded features on the disk surface. These mixing features increase the interaction between the engaging pair of disks and thus create higher stress for mixing.

### Extrusion-Based 3D Printing

Extrusion is a widely used method for 3D printing, including 3D dispensing, micro extrusion, fiber deposition, fluid dosing, or plotting. Their basic design is very similar, containing a platform, an extruder, and a motion stage. For low-viscosity, low-surface-tension fluids such as curable pre-polymer resins, a droplet deposition mode can be used for printing, but this essentially becomes a jetting process like the inkjet printing process. For high-viscosity fluids or semi-liquid such as slurries and pastes, a continuous filament/thread mode can be used. This continuous extrusion mode is believed to be useful for the micro-slurry of bio-alloys to be developed in this research. Our initial study of 3D printing with low-melting-point alloys reveals that the printing quality is sensitive to the state of the mixed material as well as printing conditions (especially speed and temperature).

The rheological property of the slurry or paste seems to be sensitive to temperature. If mixing is not adequate, extrusion becomes discontinuous, creating a non-uniform or even a random, discontinued thread. Therefore, our 3D printing process focuses on a systematic process study in conjunction with parallel mixing experiments.

Process Enhancement

In the inventive design, the overall process is enabled in a single setup with two modulated unit operations, thixotropic shearing-mixing and 3D printing, as shown in FIG. 2. In this way, the liquid-state micro-slurry from the mixer will be directly fed to the 3D printer for freeform fabrication. For comparison, we will developed an alternative method by first extruding the micro-slurry into a filament. The solidified filament was fed to the 3D printer for printing (like the FDM process). In semi-solid metal processing, it is already known that grain refinement may be achieved through the so-called strained induced metal activation (SIMA) process, where a cast alloy is first warm or cold worked and then recrystallized to obtain a refined grain structure. When reheated to a temperature between the solidus and the liquids, a semi-liquid or semi-solid is obtained. For this purpose, we re-heated the extruded Mg—Zn filament and then follow the SIMA protocol to refine the microstructure which is discussed in the following research Task 1, Thixotropic fine-grain filament fabrication process.

### Fabrication of Implantable Devices from Bio-Alloys

A Zn—Mg alloy with a suitable formulation (including addition of other effective elements) obtained above for freeform fabrication of selected medical devices. Particularly, a bone-fixation interference screw with 9 mm diameter and overall length about 25 mm (FIG. 8) is chosen as a testing device. This screw is currently made of poly (lactic acid) with a modulus more than 10 times lower than that of magnesium. For this purpose, we set the target degradation time to be 8 months. The thixotropic mixing and 3D printing conditions will be optimized for achieving the necessary performance criteria. The Zn—Mg composite material discharged from the thixotropic mixer is directly fed into the extruder for 3D printing.

The printed screws are tested for mechanical and biomedical properties.

Mechanical testing includes insertion and failure torque, cyclic displacement, and yield and ultimate pullout loads in a simulated ACL (anterior cruciate ligament) and shoulder model. Biomedical analysis includes degradation testing and in vitro characterization with human primary tenocytes and osteoblasts.

### Task 1: Design and Develop a Unique Thixotropic Fine-Grain Filament for Metal Printing

Although Extrusion-based Metal Additive Manufacturing (EMAM) has great advantages in simpler mechanisms, lower usage costs, safer working environments, larger building sizes, and less manufacturing processes, it has big challenges in printing resolution and nozzle clogging problems. In EMAM, the attainable resolution and minimum feature size are closely tied to the nozzle's diameter. The diameter of the extrusion nozzle significantly affects the quality of printed components. A larger nozzle leads to a faster deposition rate and shorter production time; however, it severely affects the dimensional accuracy of the final product. At the same time, the choice of nozzle size is constrained by the grain size of the printing materials, as materials composed of larger grains are prone to causing nozzle blockages. To avoid such clogging, firstly, a standard guideline is to select a nozzle diameter at least ten times greater than the grain sizes in the material. Secondly, grains' size must be controlled, since the larger grains lead to nozzle clogging and higher extrusion force required Thirdly, liquid segregation is another factor that can lead to nozzle clogging. During the extrusion process, the smaller grains tend to be extruded out of the orifice more smoothly, and larger grains tend to stay in the nozzle, leading to clogging eventually. Lastly, the extrusion process must be rapid, and the operation temperature window was studied since the grains will become coarse when exposed to high temperatures. To solve the dimensional accuracy and clogging problems, the present invention provides a novel system-design to rapidly heat a raw metal wire and then immediately quench the wire to receive a fine-globular-grain-filament. See process details in FIG. 9.

The raw wire used in this system first goes through the heat treatment process. The purpose of this heat treatment is to obtain a homogeneous globular morphology with an average grain size smaller than 20 um. The homogeneous globular morphology with a circular shape factor closer to 1 is desired and can avoid liquid segregation and nozzle clogging. As shown in FIG. 10, the minimal grain size is around 9 μm, with a globalization time of 5 seconds at 450° C. This indicates that finer grains are obtainable under precise thermal control, showing a great potential for high resolution thixotropic metal 3D printing since the minimal nozzle diameter can be around 9 μm×10=90 μm using the above rapid heat treatment process. FIG. 10B shows fine grains formed with quick temperature increases.

### Task 2 New Extrusion Printer Head Development

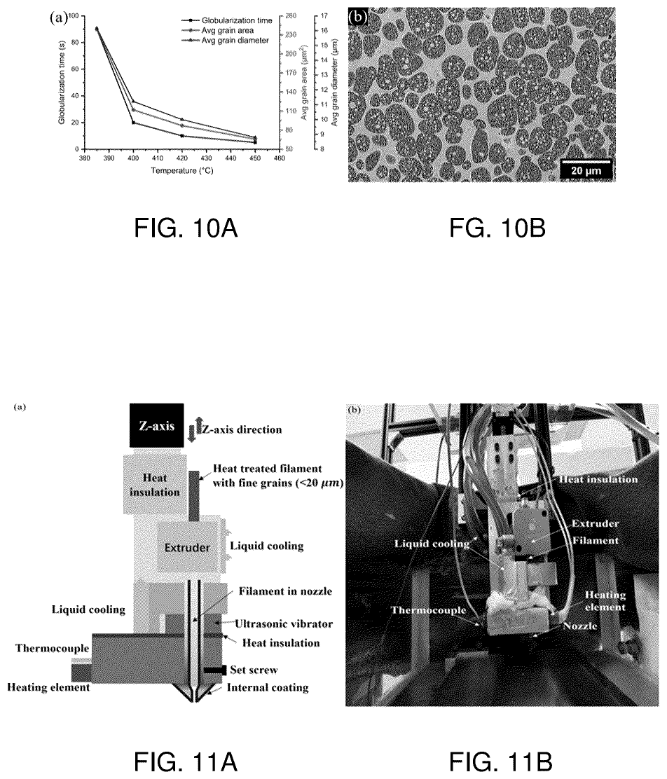

The mentioned heat-treated filament is then fed into an innovative extrusion system for printing, where the filament turns into a semi-solid slurry due to heat within a proper temperature window. The globular morphology obtained by wire heat treatment should not change during this stage. As shown in FIG. 11, this system is mounted to the Z-axis, allowing vertical movement. Temperature stands out as a pivotal element influencing the design due to the challenge of heat distribution dynamics control. Major components such as motors are safeguarded against high temperatures through heat insulation and liquid cooling. Additionally, liquid cooling aids in controlling the temperature of the filament at the nozzle's entrance, ensuring the filament remains in its original state. Notably, the heat-treated filament only experiences rapid heating at the heating zone, and the heat transfer along the filament should be controlled through three (low, middle, and high) temperature zones to accurately control the metal filament feeding through solid, semi-solid, and thixotropic three states with proper cooling. The conduction heating element is utilized as a heat source; compared with laser, electron beam, and plasma arc, conduction heating is more economical in terms of energy consumption and cost. It has been found that the metal filament temperature data and sends feedback to the nozzle temperature controller for instantaneous temperature interacts with the nozzle's inner surface, i.e. the zinc filament and steel nozzle are prone to react at elevated temperatures, that is a reaction commonly utilized in the hot-coating technique for protecting stainless steel against oxidation. This interaction significantly impacts the extrusion process, resulting in increased extrusion force, clogging/halting, and frequently inner surface cleaning which obstacles a normal printing frequently. To address this issue, the designed nozzle features a finely machined inner surface, and is coated with a non-reactive material. such as ceramic or nickel alloy. The nickel alloy coating contributes to separate print materials from the stainless-steel nozzle's internal surface. Nickel alloy maintains its mechanical properties under high temperatures and is renowned for its resistance to wear. There is an ultrasonic vibrator that directly connects to the nozzle and offers additional shear to the semi-solid state metal slurry. The shear decreases the viscosity of the semi-solid metal slurry, allowing for a smooth extrusion process. Once the semi-solid state of the material is achieved, the metal alloy slurry goes through the extrusion process. In this phase, the extrusion force and ultrasonic vibration provide shears to increase the semi-solid slurry's fluid ability (decrease in viscosity) due to the shear-thinning behavior, thus, better printability and higher resolution of the extruded part can be achieved.

### Task 3—Innovative Inert Gas Protection System Design

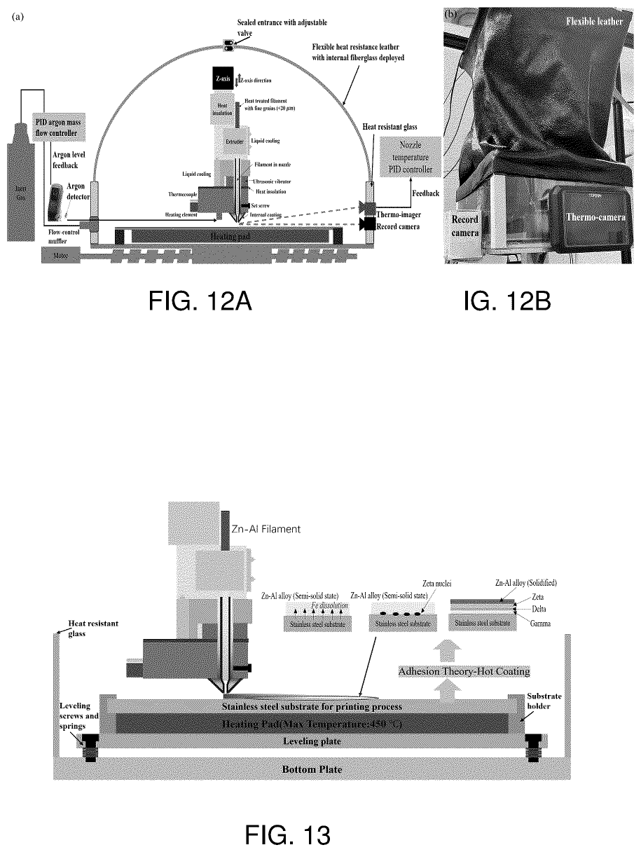

Biodegradable metals, such as magnesium (Mg) and zinc (Zn) based alloys, naturally form a protective oxidation layer. Although both Zn and Mg have relatively low melting points (519.5° C. and 650° C., respectively), their oxides melt at temperatures around 2000° C. or higher. This oxide presence compromises the structural integrity and mechanical strength of the printed items. Therefore, the use of inert gas protection is essential in the 3D thixotropic metal printing system. Traditionally, a large-scale gas protection box is employed to cover/enclosure the whole machine area, which is not only costly, bulky but also demands specialized facilities. A more adaptable gas protection system is introduced, as shown in FIG. 12. The localized inert gas protection system comprises several subsystems. Firstly, a specific zone is established using a gas chamber made of flexible heat-resistance fabrics, where the chamber is constructed from a metal plate equipped with four heat-resistant glasses. To guarantee a tight seal against gas exposure, fiberglass materials line the interior surfaces of the fabrics. An inert gas detector probe is mounted close to the nozzle tip. The inert gas can be argon. The flow of argon gas is meticulously regulated by a PID argon mass flow controller, which adjusts the argon levels based on real-time feedback of the argon level. The argon level is controlled within 99%, a tolerance of 1%, based on the PID flow control design. The building size is 200 mm×150 mm×60 mm, and it can be increased with a larger gas chamber design. Secondly, A camera (resistant to high temperatures), is installed on one of the glass windows to oversee and record the printing activity. Besides, monitoring the temperature at the nozzle tip and the material being printed is crucial in the thixotropic printing process; thus, a thermal imager captures temperature data and sends feedback to the nozzle temperature controller for instantaneous temperature adjustment. All the electric wires of the system are connected with the power sources and controllers through a top valve that was designed to reduce argon escape and seal the entrance.

### Task 4—Hot Coating Theory and Thermal Transfer Model for Metal-Substrate Adhesion

The adhesion between the first layer and the substrate is essential for achieving stable, successful, and accurate printing. Meanwhile, the heat exchange between the first layer and the substrate influences the thermal dynamics of the deposited layer. This, in turn, impacts the solidification process and the quality of the metal product. The current metal printing needs an extra EDM (Electrical Discharge Machining) to separate the printed object from the substrate. Additionally, a new substrate is required for each printing cycle. These complex steps substantially elevate the operational expenses in Metal Additive Manufacturing and impose considerable constraints on its application within the industry. For instance, the costs to remove the part from SLM machines and separate the part from substrate are 7.14%, and 3.35%, respectively. To address the limitations of the current substrate adhesion mechanism, a new method is proposed. The new adhesion method is sourced from creating intermetallic phase layers with hot-coating process and FIG. 13 shows detailed terminology and mechanism.

For zinc alloy deposition and stainless-steel substrate, first, the Fe from the surface of the substrate begins to dissolve into the liquid state zinc, creating a localized area of Fe supersaturation close to the substrate. This surplus of Fe interacts with liquid state zinc, leading to the formation of various Fe—Zn intermetallic phases, such as gamma, gamma1, delta, and zeta, see FIG. 13. At the temperature used for hot coating, these Fe—Zn intermetallic phases remain solid and to form heterogeneously on the steel substrate; following this, as the iron supersaturation increases, the delta phase starts to nucleate at the interface between the steel and the zeta phase. In a similar manner, the gamma phase develops at the interface between the steel and the delta phase. The kinetics of Fe—Zn alloy layer growth can be explained in the model as follows.

$$Y = {Kt}^{n} \qquad Eqn . 1$$

Where Y is the growth layer thickness, t is the reaction time, K is the growth-rate constant, and n is the growth-rate time-constant.

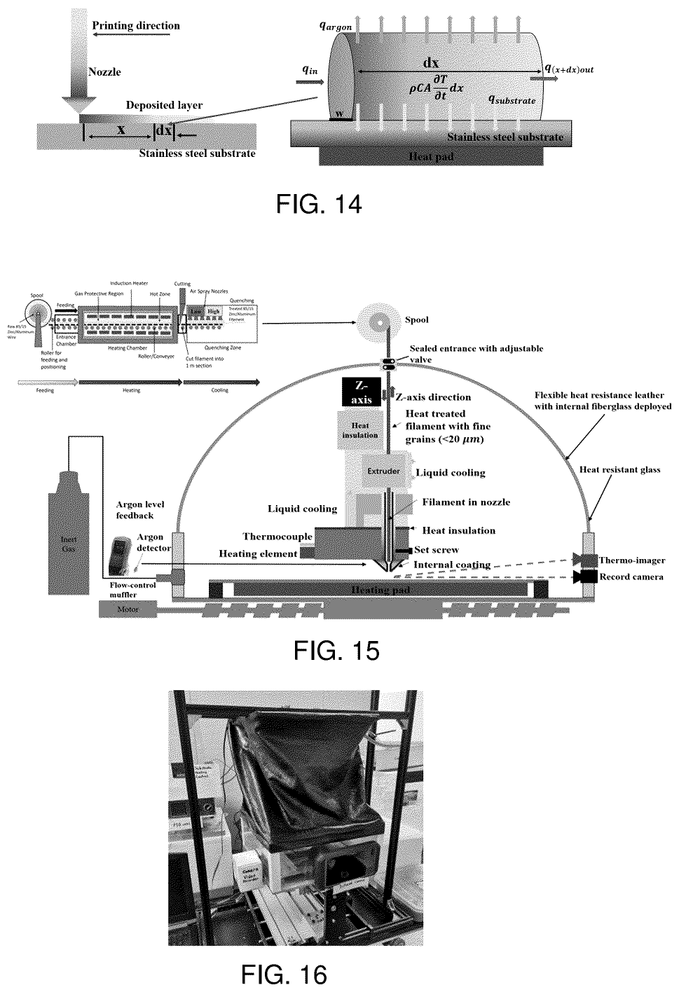

Heat transfer plays a critical role in adhesion between the first layer and the substrate. The theoretical heat transfer model is illustrated in FIG. 14.

In FIG. 14, qᵢₙ represents the energy input from the heat source on the left side, q_{(x+dx)out} represents the energy output from the right side of the printed filament, q_{argon} is the convection energy output to the argon, q_{sub} is the convection energy transfer from filament to substrate, and the internal energy change can be expressed as follows:

$$Δ q = pCA ( δ T / δ x ) = A δ ( k ( δ T / δ x ) ) / δ x - Hs ( T - {T}_{e} ) , \\ 0 < x < vt , t > 0 \qquad Eqn . 2$$

k represents the thermal conductivity of the metal material, while A denotes its cross-sectional area. T is the average temperature within the cross-section. The s stands for the cross-sectional perimeter of the deposited layer. v represents the printing speed. The contact width between the cross-section of the deposited layer and the substrate is I_{w}. Tₑ indicates the environmental temperature. The density of the metal material is represented by ρ, C is its specific heat capacity, and h is the effective convective heat transfer coefficient, which can be obtained by experiments and calculations through following equation.

$$h = {h}_{argon} ( 1 - ( {l}_{w} / s ) + {h}_{sub} ( {l}_{w} / s ) \qquad Eqn . 3$$

Based on the hot coating theory and thermal transfer model, the substrate adhesion test was successfully conducted. It was found that sufficient adhesion was achieved with a substrate temperature of 280° C. and a nozzle tip temperature of 450° C. for Zn—Al alloy thixotropic metal printing. Meanwhile, it was found that the adhesion between the printed object and substrate was not a fully fused bonding, and the printed sample could be removed with a minor amount of shear force, which posed a great advantage to eliminate the traditional EDM cutting separation process. It is notable that many other metal alloys, such as lead-tin alloy, magnesium alloy, aluminum alloy, and copper alloy, have been applied to hot-coating process and can be adopted into this adhesion mechanism in Metal Additive Manufacturing.

### Results

### A Complete System Design and Prototype Machine

3D thixotropic metal printing is a new manufacturing process that utilizes the metal alloy's thixotropic property (shear-thinning behavior) to accomplish additive manufacturing (see FIG. 15). A special processed alloy filament is used as a feeding stock to start printing, then a feeding device transports the metal alloy filament into a heating zone and an exchangeable nozzle with a desired speed. A heating system provides proper and controllable heating and makes the filament into a desired, semi-solid temperature zone. The printing area is in an argon protection environment since the oxidation of the printed material leads to printing failure. An adjustable heated substrate offers a leveled printing surface with heat, which helps to balance the heating dynamics between the nozzle and substrate. An XYZ moving stage contributes to 3D object manufacturing. A picture of the prototype machine is shown in FIG. 16.

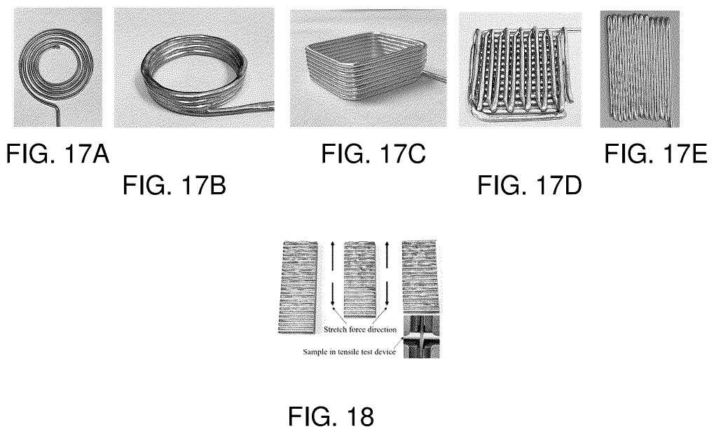

In FIGS. 17A-17E, all samples were manufactured in Zn85-A115 material, 2 mm filament; 450 degrees C.; printing speed: 72 mm/min; and they are: (FIG. 17A) a 80 mm dia. Spiral; (FIG. 17B) a 5 layer 10 mm height, 60 mm dia. Ring; (FIG. 17C) a 8 layer 16 mm height, 40×60 mm² Basket; (FIG. 17D) a 2 layer Grid structure, 60×60×4 mm³; (FIG. 17E) a Plate with 24 lines, 60×48×2 mm³.

### 6. 3. Mechanical Testing

To examine the mechanical integrity of printed products, tests were conducted. 1. First layer with substrate adhesion strength test: three sample were printed, for each with contact area 1.6×10 mm², the average maximum separation force was 52 N, the resulted adhesion strength is 32.5 Kpa, which is strong enough for printed object to remain on its position and is easy to take it off after the printing. 2. Tensile strength test: six raw wires and six thixotropic printed wires were prepared. The average UTS of raw wires was 184.1 MPa, and average for printed wires was 193.3 that gave a 5% increase on UTS. The printed filaments were produced under the same experimental setup, and the results are shown as follows. 3. In X-Z surface layer to layer adhesion strength test: three samples were prepared, see FIG. 18; it has been calculated that the inter-layer adhesion UTS is 50.73 MPa. 4. In X-Y surface, three samples similar to FIG. 18 were prepared, and obtained inter-line adhesion UTS is 90.39 MPa. As in FIG. 18, the printing is in horizontal direction and stretch force in vertical direction.

### Broader Impacts

Extrusion-based freeform fabrication of bio-metallic devices combining strength, biocompatibility, and suitable biodegradability is highly desirable in medical surgery. The thixotropic processing and 3D printing technology resulting from this project is expected to dramatically impact skeletal and soft tissue fixation tools, vascular inflation stents, and bone tissue scaffolds. This can lead to a revolutionary improvement particularly in orthopedic, spinal, and vascular surgery by providing patient-tailored medical devices that are strong and can degrade and be absorbed in vivo. Patients would be able to receive affordable and yet personalized treatment. Although the present invention focuses on Zn/Mg based alloys and medical applications, the process and equipment design may be adapted to 3D printing of other alloys such as AI-based alloys for broad industrial applications.

The Ph.D. thesis entitled “Design, Prototype, and Experiments for a Thixotropic Metal 3D Printing System”, by Jie Xu in May 2024 is incorporated herein by reference as if fully set forth.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A thixotropic printing device comprising:
a heating chamber configured to accept a filament, the filament containing grains having a grain size;
an extrusion system located downstream of the heating chamber, the extrusion system being configured to convert the filament into a semi-solid slurry, the extrusion system having:
a cooler configured to cool the filament; and
a nozzle downstream of the cooler, the nozzle having a nozzle diameter at least ten times greater than the grains size; and
a substrate configured to receive a discharge from the nozzle.

2. The thixotropic printing device according to claim 1, wherein the heating chamber comprises three temperature zones.

3. The thixotropic printing device according to claim 1, wherein the nozzle is coated with a non-reactive material.

4. The thixotropic printing device according to claim 3, wherein the coating is selected from the group consisting of ceramic nickel alloy.

5. The thixotropic printing device according to claim 1, further comprising an ultrasonic vibrator connected to the nozzle.

6. The thixotropic printing device according to claim 1, further comprises a heating pad located below the substrate.

7. The thixotropic printing device according to claim 1, wherein the substrate has a temperature of 280° C. and the nozzle has a nozzle tip temperature of 450° C. for Zn—Al alloy thixotropic metal printing.

8. The thixotropic printing device according to claim 1, wherein the heating chamber is configured to accept a Zn—Al alloy filament, and wherein the substrate is comprised of stainless steel.

9. The thixotropic printing device according to claim 8, wherein iron from the stainless steel is configured to dissolve into zinc from the filament.

10. The thixotropic printing device according to claim 1, further comprising an inert gas protector covering the extrusion system.

11. The thixotropic printing device according to claim 10, wherein the inert gas protector comprises:
a cover;
an inert gas supply connected to the cover and in communication with
an interior of the cover; and
a processed material inlet configured to pass metal from the outlet ort to the extruder through the cover.

12. The thixotropic printing device according to claim 11, wherein the processed material inlet comprises a sealed entrance with an adjustable valve.

13. The thixotropic printing device according to claim 11, further comprising an imaging device configured to record inside the cover.

14. The thixotropic printing device according to claim 10, wherein the inert gas protector further comprises an inert gas detector.

15. A method of 3D printing a metal comprising the steps of:
(a) using the thixotropic printing device according to claim 9;
(b) adding the metal to the melting furnace and melting the metal, forming a slurry;
(c) transferring the slurry to the inlet port;
(d) processing the slurry;
(e) discharging the processed slurry from the outlet port to the extruder; and
(f) extruding the metal onto a substrate.

16. The method according to claim 15, wherein the step of adding the metal comprises adding zinc and magnesium.

17. The method according to claim 15, wherein step (b) comprises melting the metal at a temperature over 550° C.

18. The method according to claim 17, wherein step (f) comprises extruding the metal from a nozzle tip of the extruder, the nozzle tip having a temperature of about 450° C.
